(19) United States
(12) Patent Application Publication
(10) Pub. No.: US 2008/0068508 A1
(43) Pub. Date: Mar. 20, 2008

(54) Signal processing apparatus, signal processing method, and program

(75) Inventors: Tsutomu Ichinose, Tochigi (JP); Takashi Sato, Tokyo (JP); Yoshiro Miyoshi, Kanagawa (JP); Kazuyoshi Takahashi, Tokyo (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 11/900,548

(22) Filed: Sep. 11, 2007

(30) Foreign Application Priority Data
Sep. 15, 2006 (JP) JP2006-251135

(51) Int. Cl. H04N 9/65

(52) U.S. Cl. 348/642; 348/E09.045

(57) ABSTRACT

In a signal processing apparatus, when a luminance signal in a first numeric range is assigned to an integer value in a second range narrower than a first range representable by predetermined bits, and a luminance signal and color-difference signals are outputted under a predetermined standard in which a color-difference signal in a second numeric range is assigned to an integer value in a third range narrower than the first range, the luminance signal in the first numeric range is assigned to an integer value in a fourth range between the first and second ranges; the color-difference signal in the second numeric range is assigned to an integer value in a fifth range between the first and third ranges; and the fourth range is adjusted in a range between the first range and second range, and the fifth range is adjusted in a range between the first and third ranges.

### CROSS REFERENCES TO RELATED APPLICATIONS

The present invention contains subject matter related to Japanese Patent Application JP 2006-251135 filed in the Japanese Patent Office on Sep. 15, 2006, the entire contents of which being incorporated herein by reference.

### BACKGROUND OF THE INVENTION

1. Field of the Invention

The present invention relates to a signal processing apparatus, a signal processing method, and a program, particularly to a signal processing apparatus, a signal processing method, and a program which can represent colors in a color gamut wider than a color gamut before in video signal processing.

2. Description of the Related Art

Data compression processing compliant to ITU-R (International Telecommunication Union Radiocommunication sector) BT (Broadcasting service (Television)).709 (hereinafter, simply referred to as BT.709 (see Non-Patent Reference 1 (RECOMMENDATION ITU-R BT.709-4)) will be described.

For example, in video cameras, color signals are obtained by imaging, and then subjected to A/D conversion, and color signals R, G and B thus obtained are converted into color signals R, G and B in primary colors based on primary colors according to BT.709.

The color signals R, G and B converted in primary colors are corrected to color signals R, G and B in the numeric range of 0 to 1.0 defined by BT.709. In other words, for example, the color signals R, G and B smaller than zero are corrected (clipped) to zero, whereas the color signals R, G and B greater than 1.0 are corrected to 1.0. In addition, here, suppose that 0 and 1.0 in the numeric range of 0 to 1.0 are the minimum value and the maximum value of the color signals R, G and B compliant to BT.709, respectively.

The color signals R, G and B corrected to the numeric range of 0 to 1.0 are converted into the color signals R, G and B that are corrected by γ (the nonlinearity of luminous brightness for image signals) of a display mechanism of BT.709 in accordance with the photoelectric conversion properties compliant to BT.709.

The photoelectric conversion properties here are defined in the range of the minimum value to the maximum value of the color signals R, G and B compliant to BT.709, that is, 0 to 1.0.

The color signals R, G and B corrected by γ (the nonlinearity of luminous brightness for image signals) of the display mechanism of BT.709 are converted into a luminance signal Y and color difference signals CB/CR compliant to BT.709.

According to BT.709, the luminance signal Y obtained here has the value in the numeric range of 0 to 1.0. In addition, the color difference signals CB/CR have a value in the numeric range of −0.5 to 0.5.

The luminance signal Y and the color difference signals CB/CR converted in compliance with BT.709 are represented by eight bits.

More specifically, as shown in FIG. 1A, the luminance signal Y in the numeric range of 0 to 1.0 is assigned to integer values in the integer range of 16 to 235 that is narrower than the integer range of 0 to 255 representable by eight bits.

In other words, to the luminance signal Y, eight bits of integer values are assigned so that the undershoot region of 1 to 15 and the overshoot region of 236 to 254 are provided.

Moreover, as shown in FIG. 1B, the color difference signals CB/CR in the numeric range of −0.5 to 0.5 are assigned to integer values in the integer range of 16 to 240 that is narrower than the integer range of 0 to 255 representable by eight bits.

In other words, to the color difference signals CB/CR, eight bits of integer values are assigned so that the undershoot region of 1 to 15 and the overshoot region of 241 to 254 are provided.

In addition, in the luminance signal Y and the color difference signals CB/CR, 0 and 255 are not used.

The luminance signal Y having such integer values is encoded in accordance with a predetermined format such as MPEG (Moving Picture Experts Group) as the luminance signal compliant to BT.709, and the color difference signals CB/CR having integer values are encoded in accordance with the same format as the luminance signal, as the color difference signal compliant to BT.709. The encoded data thus obtained is recorded on a recording medium, or outputted on a network.

As described above, the color signals are processed in accordance with the BT.709 standards, whereby a television set can process the color signals in compliance with BT.709.

### SUMMARY OF THE INVENTION

In recent years, such a display device is developed that can display the luminance signal Y and the color difference signals CB/CR in the overshoot region and the undershoot region, in the luminance signal Y and the color difference signals CB/CR, that is, for example, that can represent colors in a wider color gamut than that represented in compliance with predetermined standards such as BT.709.

However, in the data compression method described above, since the luminance signal Y and the color difference signals CB/CR are not assigned to the overshoot region and the undershoot region, it is difficult to provide compressed data that meets a display device which can represent colors in a wider color gamut.

Thus, it is desirable to provide signals that can represent colors in a wider color gamut than that represented in compliance with predetermined standards such as BT.709.

A signal processing apparatus according to an embodiment of the invention is a signal processing apparatus in which a luminance signal in a first numeric range is assigned to an integer value in a second integer range that is narrower than a first integer range representable by a plurality of predetermined bits for representation, and a luminance signal and color difference signals are outputted in compliance with a predetermined standard in which a color difference signal in a second numeric range is assigned to an integer value in a third integer range that is narrower than the first integer range for representation, the signal processing apparatus including: a luminance signal assigning means for assigning the luminance signal in the first numeric range to an integer value in a fourth integer range that is narrower than the first integer range and wider than the second integer range; a color difference signal assigning means for assigning the color difference signals in the second numeric range to an integer value in a fifth integer range that is narrower than the first integer range and wider than the third integer range; and an adjusting means for adjusting the fourth integer range in a range that is narrower than the first integer range and wider than the second integer range, and adjusting the fifth integer range in a range that is narrower than the first integer range and wider than the third integer range.

A signal processing method according to an embodiment of the invention is a signal processing method in which a luminance signal in a first numeric range is assigned to an integer value in a second integer range that is narrower than a first integer range representable by a plurality of predetermined bits for representation, and a luminance signal and color difference signals are outputted in compliance with a predetermined standard in which a color difference signal in a second numeric range is assigned to an integer value in a third integer range that is narrower than the first integer range for representation, the signal processing method including the steps of: assigning the luminance signal in the first numeric range to an integer value in a fourth integer range that is narrower than the first integer range and wider than the second integer range; assigning the color difference signals in the second numeric range to an integer value in a fifth integer range that is narrower than the first integer range and wider than the third integer range; and adjusting the fourth integer range in a range that is narrower than the first integer range and wider than the second integer range, and adjusting the fifth integer range in a range that is narrower than the first integer range and wider than the third integer range.

A program according to an embodiment of the invention is a program which allows a computer to execute an output process in which a luminance signal in a first numeric range is assigned to an integer value in a second integer range that is narrower than a first integer range representable by a plurality of predetermined bits for representation, and a luminance signal and color difference signals are outputted in compliance with a predetermined standard in which a color difference signal in a second numeric range is assigned to an integer value in a third integer range that is narrower than the first integer range for representation, the output process including the steps of: assigning the luminance signal in the first numeric range to an integer value in a fourth integer range that is narrower than the first integer range and wider than the second integer range; assigning the color difference signals in the second numeric range to an integer value in a fifth integer range that is narrower than the first integer range and wider than the third integer range; and adjusting the fourth integer range in a range that is narrower than the first integer range and wider than the second integer range, and adjusting the fifth integer range in a range that is narrower than the first integer range and wider than the third integer range.

In the signal processing apparatus, the signal processing method, and the program according to an embodiment of the invention, in the case in which a luminance signal in a first numeric range is assigned to an integer value in a second integer range that is narrower than a first integer range representable by a plurality of predetermined bits for representation, and a luminance signal and color difference signals are outputted in compliance with a predetermined standard in which a color difference signal in a second numeric range is assigned to an integer value in a third integer range that is narrower than the first integer range for representation, the luminance signal in the first numeric range is assigned to an integer value in a fourth integer range that is narrower than the first integer range and wider than the second integer range; the color difference signal in the second numeric range is assigned to an integer value in a fifth integer range that is narrower than the first integer range and wider than the third integer range; and the fourth integer range is adjusted in a range that is narrower than the first integer range and wider than the second integer range, and the fifth integer range is adjusted in a range that is narrower than the first integer range and wider than the third integer range.

According to an embodiment of the invention, for the signals that can be treated in compliance with predetermined standards such as BT.709, color signals in a wider color gamut can be outputted depending on the display performance capabilities of display devices.

### BRIEF DESCRIPTION OF THE DRAWINGS

FIGS. 1A and 1B shows a diagram illustrative of the passband of the luminance signal and the color difference signal in accordance with BT.709;

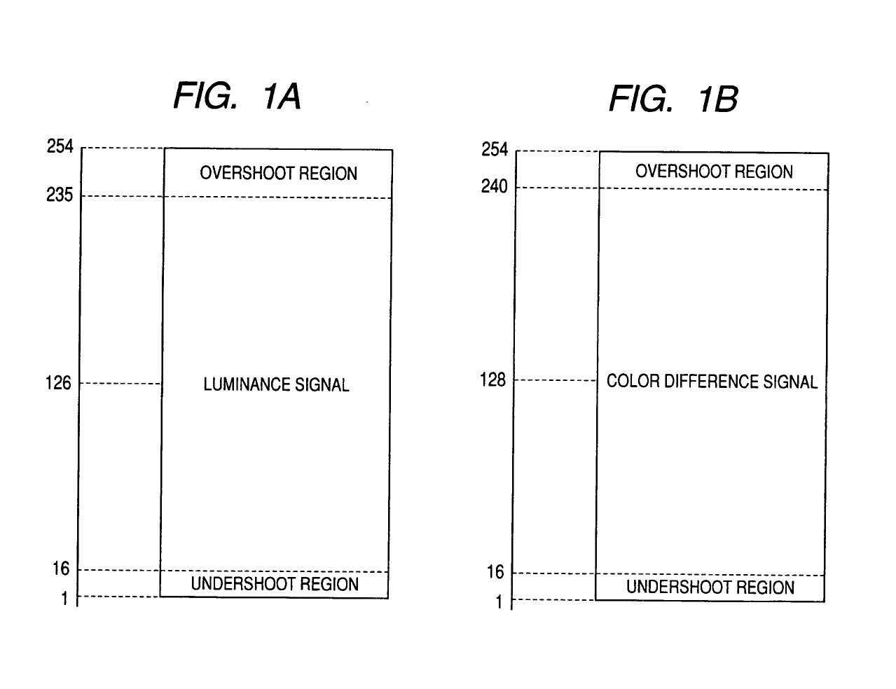

FIG. 2 shows a block diagram depicting an exemplary configuration of a data compressor to which an embodiment of the invention is adapted;

FIG. 3 shows a flow chart illustrative of the operation of an input data passband control part shown in FIG. 2;

FIG. 4 shows a flow chart illustrative of the operation of a luminance overshoot passband adjusting circuit shown in FIG. 2;

FIG. 5 shows a flow chart illustrative of the operation of a luminance undershoot passband adjusting circuit shown in FIG. 2;

FIG. 6 shows a flow chart illustrative of the operation of a color difference passband adjusting circuit shown in FIG. 2;

FIGS. 7A and 7B show a diagram depicting an exemplary passband according to an embodiment of the invention; and

FIG. 8 shows a block diagram depicting an exemplary configuration of a computer to which an embodiment of the invention is adapted.

### DETAILED DESCRIPTION OF THE INVENTION

Hereinafter, an embodiment of according to an embodiment of the invention will be described. The following is examples of the correspondence between configuration requirements for according to an embodiment of the invention and the embodiments of the specification or the drawings. This is described for confirming that the embodiments supporting according to an embodiment of the invention are described in the specification or the drawings. Therefore, even though there is an embodiment that is described in the specification or the drawings but is not described herein as an embodiment corresponding to configuration requirements for the invention, it does not mean that the embodiment does not correspond to those configuration requirements. Contrary to this, even though an embodiment is described herein as an embodiment corresponding to configuration requirements, it does not mean that the embodiment does not correspond to configuration requirements other than those configuration requirements.

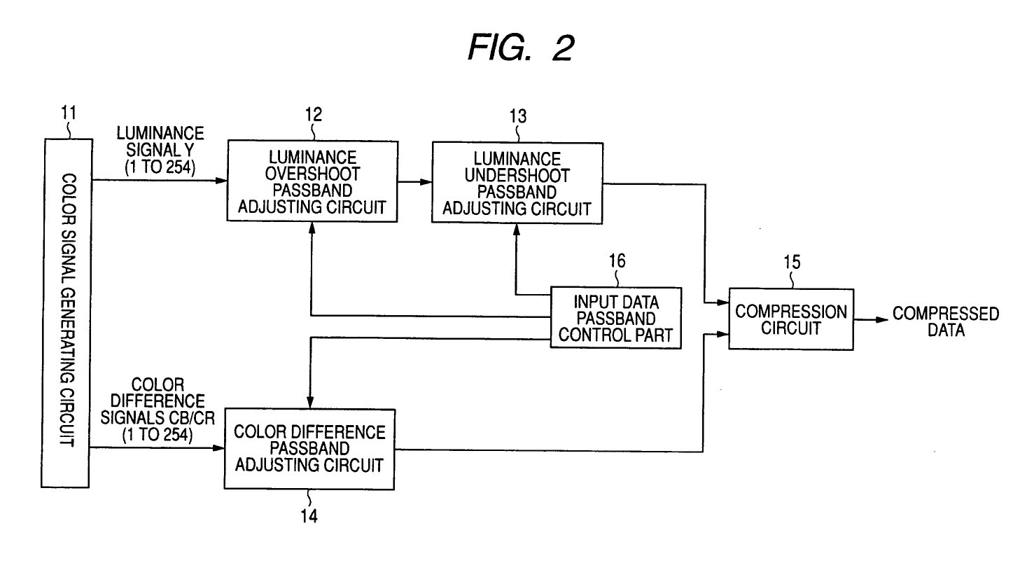

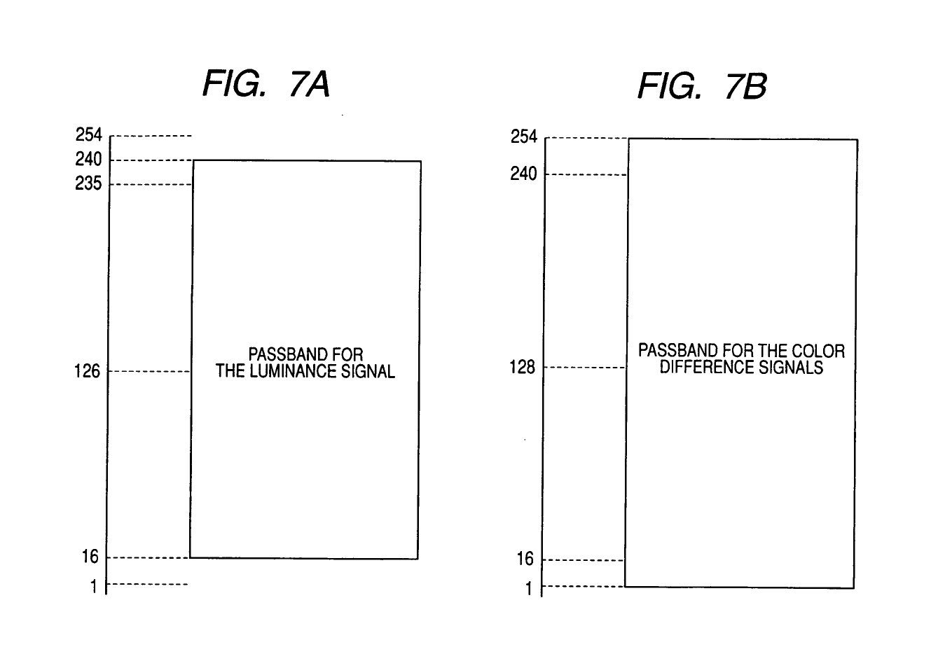

A signal processing apparatus according to an embodiment of the invention is a signal processing apparatus in which a luminance signal in a first numeric range (0 to 255) is assigned to an integer value in a second integer range (for example, 16 to 235) that is narrower than a first integer range representable by a plurality of predetermined bits (for example, eight bits) for representation, and a luminance signal and color difference signals are outputted in compliance with a predetermined standard in which a color difference signal in a second numeric range is assigned to an integer value in a third integer range (for example, 16 to 240) that is narrower than the first integer range (for example, 0 to 255) for representation, the signal processing apparatus including: a luminance signal assigning means (for example, a luminance overshoot passband adjusting circuit 12 shown in FIG. 2 or a luminance undershoot passband adjusting circuit 13) for assigning the luminance signal in the first numeric range to an integer value in a fourth integer range (for example, 16 to 240) that is narrower than the first integer range and wider than the second integer range (for example, FIG. 7A); a color difference signal assigning means (for example, a color difference passband adjusting circuit 14 shown in FIG. 2) for assigning the color difference signals in the second numeric range to an integer value in a fifth integer range that is narrower than the first integer range and wider than the third integer range; and an adjusting means for adjusting (for example, an input data passband control part 16 shown in FIG. 2) the fourth integer range in a range that is narrower than the first integer range and wider than the second integer range, and adjusting the fifth integer range in a range that is narrower than the first integer range and wider than the third integer range.

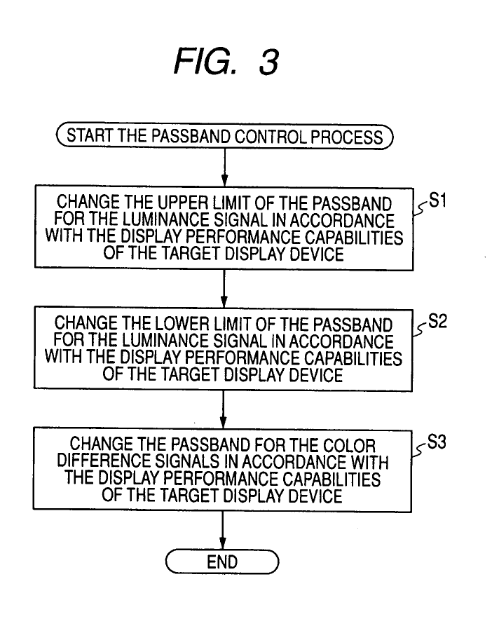

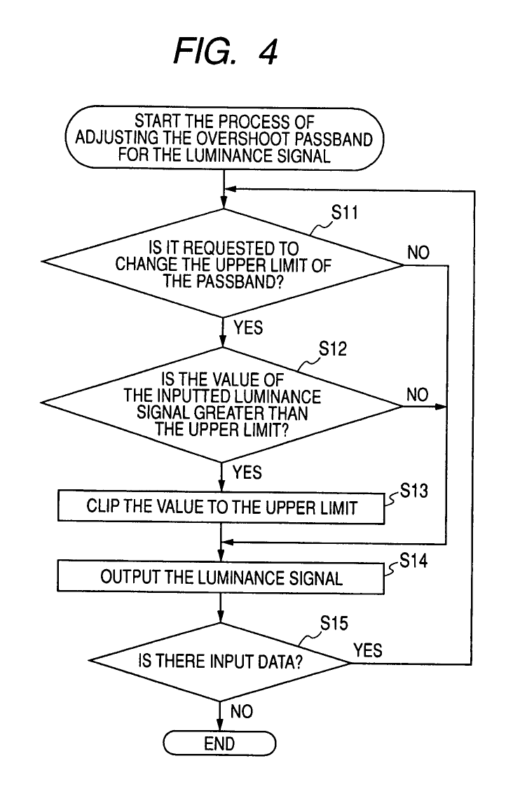

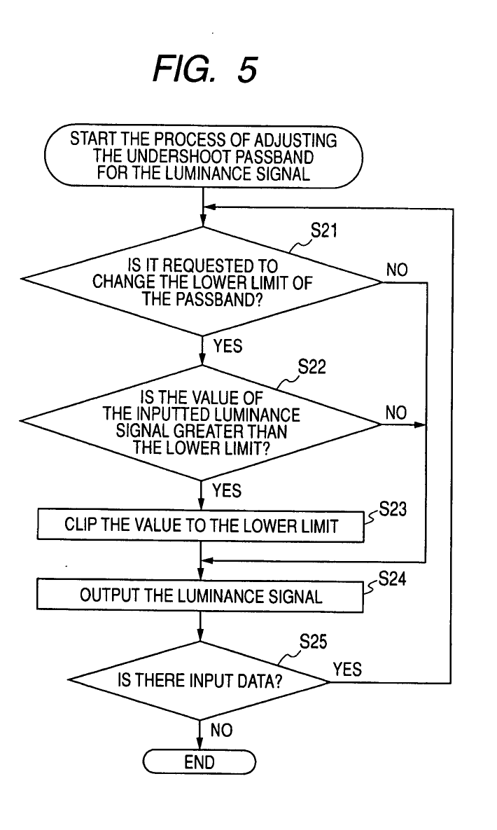

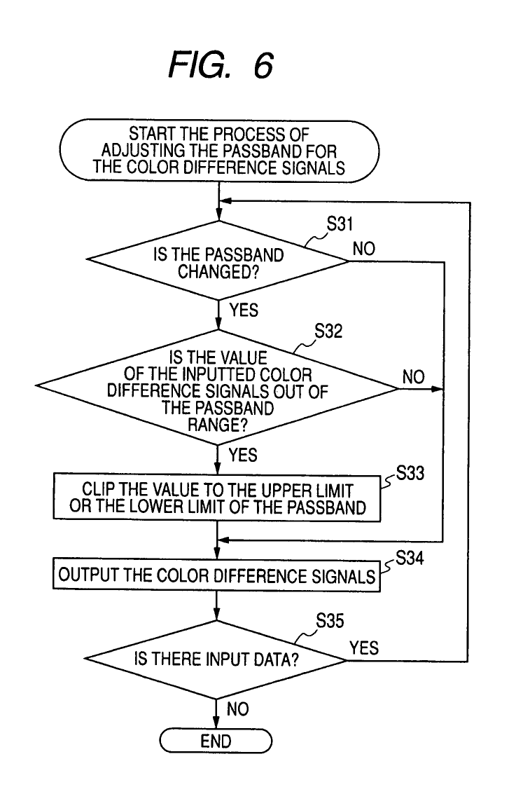

A signal processing method, or a program according to an embodiment of the invention is a signal processing method in which a luminance signal in a first numeric range is assigned to an integer value in a second integer range that is narrower than a first integer range representable by a plurality of predetermined bits for representation, and a luminance signal and color difference signals are outputted in compliance with a predetermined standard in which a color difference signal in a second numeric range is assigned to an integer value in a third integer range that is narrower than the first integer range for representation, or a program which allows a computer to execute an output process in which a luminance signal in a first numeric range is assigned to an integer value in a second integer range that is narrower than a first integer range representable by a plurality of predetermined bits for representation, and a luminance signal and color difference signals are outputted in compliance with a predetermined standard in which a color difference signal in a second numeric range is assigned to an integer value in a third integer range that is narrower than the first integer range for representation, including the steps of: assigning the luminance signal in the first numeric range to an integer value in a fourth integer range that is narrower than the first integer range and wider than the second integer range (for example, Step S13 in FIG. 4 or Step S23 in FIG. 5); assigning the color difference signals in the second numeric range to an integer value in a fifth integer range that is narrower than the first integer range and wider than the third integer range (for example, Step S33 in FIG. 6); and adjusting the fourth integer range in a range that is narrower than the first integer range and wider than the second integer range, and adjusting the fifth integer range in a range that is narrower than the first integer range and wider than the third integer range (for example, Step S1 to Step S3 in FIG. 3).

FIG. 2 shows an exemplary configuration of a data compressor to which an embodiment of the invention is adapted.

A color signal generating circuit 11 subjects color signals R, G and B obtained by imaging pictures by means of a shooting part, not shown, to A/D conversion, and converts the signals into color signals R, G and B in primary colors based on primary colors in compliance with BT.709.

The color signal generating circuit 11 subjects the color signals R, G and B converted in primary colors to photoelectric conversion in accordance with the photoelectric conversion properties, converts the color signals R, G and B after photoelectric conversion into a luminance signal Y and color difference signals CB/CR, and corrects the luminance signal Y to a luminance signal in a predetermined numeric range and the color difference signals CB/CR to color difference signals in a predetermined numeric range (for example, −0.57 to 0.56).

The color signal generating circuit 11 assigns the luminance signal Y after corrected to integer values in the integer range of 1 to 254 that is narrower than the integer range of 0 to 255 representable by eight bits, and outputs the luminance signal Y of the integer values to a luminance overshoot passband adjusting circuit 12.

The color signal generating circuit 11 also assigns the color difference signals CB/CR after corrected to integer values in the integer range of 1 to 254 that is narrower than the integer range of 0 to 255 representable by eight bits, and outputs the color difference signals CB/CR of the integer values to a color difference passband adjusting circuit 14.

The luminance overshoot passband adjusting circuit 12 adjusts the highest value (hereinafter, referred to as an upper limit) of the passband (in the integer range of 1 to 254) of the luminance signal Y in accordance with control done by an input data passband control part 16.

The luminance overshoot passband adjusting circuit 12 passes the luminance signal Y in the integer range of 1 to 254 supplied from the color signal generating circuit 11 through the adjusted passband, and supplies the luminance signal Y passed through the band to a luminance undershoot passband adjusting circuit 13.

The luminance undershoot passband adjusting circuit 13 adjusts the lowest value (hereinafter, referred to as a lower limit) of the passband (in the integer range of 1 to 254) of the luminance signal Y in accordance with control done by the input data passband control part 16.

The luminance undershoot passband adjusting circuit 13 passes the luminance signal Y supplied from the luminance overshoot passband adjusting circuit 12 through the adjusted passband, and supplies the luminance signal Y passed through the band to a compression circuit 15.

The color difference passband adjusting circuit 14 adjusts the upper limit and the lower limit of the band (the integer range of 1 to 254) of the color difference signals CB/CR by the same size in accordance with control done by the input data passband control part 16 (that is, the upper limit is made smaller by N, whereas the lower limit is made greater by the same N).

The color difference passband adjusting circuit 14 passes the color difference signals CB/CR in the integer range of 1 to 254 supplied from the color signal generating circuit 11 through the adjusted passband, and supplies the color difference signals CB/CR passed through the band to the compression circuit 15.

The compression circuit 15 encodes the luminance signal Y supplied from the luminance undershoot passband adjusting circuit 13 and the color difference signals CB/CR supplied from the color difference passband adjusting circuit 14 in accordance with a predetermined format such as MPEG (Moving Picture Experts Group), and externally outputs the encoded data thus obtained to a recording medium or a network.

Next, the operation of the input data passband control part 16 will be described with reference to a flow chart shown in FIG. 3.

In Step S1, the input data passband control part 16 requests the luminance overshoot passband adjusting circuit 12 to change the upper limit of the band for the luminance signal Y to a predetermined value in accordance with the display performance capabilities of a display device (hereinafter, referred to as a target display device), not shown, that displays data compressed in a data compression process to be performed, for example. In addition, in the case in which no changes are necessary (that is, in the case in which the upper limit of the luminance signal Y corresponding to the display performance capabilities of the target display device is 254), this is notified.

In Step S2, the input data passband control part 16 requests the luminance undershoot passband adjusting circuit 13 to change the lower limit of the band for the luminance signal Y to a predetermined value in accordance with the display performance capabilities of the target display device. In addition, in the case in which no changes are necessary (that is, in the case in which the lower limit of the luminance signal Y corresponding to the display performance capabilities of the target display device is 1), this is notified.

Subsequently, in Step S3, the input data passband control part 16 requests the color difference passband adjusting circuit 14 to change the range of the passband for the color difference signals CB/CR to a predetermined range corresponding to the range of the display performance capabilities of the target display device. In addition, in the case in which no changes are necessary (that is, in the case in which the band of the color difference signals CB/CR corresponding to the display performance capabilities of the target display device is from 1 to 254), this is notified.

As described above, the luminance overshoot passband adjusting circuit 12, the luminance undershoot passband adjusting circuit 13 and the color difference passband adjusting circuit 14 are requested to change (that is, adjust) the passbands for the luminance signal Y and the color difference signals CB/CR, and then the process is ended.

Next, the operation of the luminance overshoot passband adjusting circuit 12 will be described with reference to a flow chart shown in FIG. 4.

In Step S11, the luminance overshoot passband adjusting circuit 12 determines whether the input data passband control part 16 makes a request for changing the upper limit of the passband for the luminance signal Y in Step S1 in FIG. 3. If it determines that a request is made, it goes to Step S12.

In Step S12, the luminance overshoot passband adjusting circuit 12 determines whether the value of the luminance signal Y is greater than the requested upper limit of the passband. If it determines that the value is greater, it goes to Step S13, and clips (corrects) the value of the luminance signal Y now inputted to the same value as the upper limit.

If it is determined that no request is made for changing the upper limit of the passband in Step S11 (that is, if it is notified that the upper limit is not changed), if it is determined that the value of the luminance signal Y now inputted is equal to or below the upper limit of the passband in Step S12, or if it is determined that the value of the luminance signal Y is clipped to the upper limit of the passband in Step S13, the luminance overshoot passband adjusting circuit 12 goes to Step S14, and outputs the value of the luminance signal Y to the luminance undershoot passband adjusting circuit 13.

In Step S15, the luminance overshoot passband adjusting circuit 12 determines whether the luminance signal Y is inputted from the color signal generating circuit 11. If it determines that the luminance signal Y is inputted, it returns to Step S11, and similarly performs the process steps after that for the inputted luminance signal Y.

If it is determined that the luminance signal Y is not inputted from the color signal generating circuit 11 in Step S15, the luminance overshoot passband adjusting circuit 12 ends the process.

Next, the operation of the luminance undershoot passband adjusting circuit 13 will be described with reference to a flow chart shown in FIG. 5.

In Step S21, the luminance undershoot passband adjusting circuit 13 determines whether the input data passband control part 16 makes a request for changing the lower limit of the passband for the luminance signal Y in Step S2 in FIG. 3. If it determines that a request is made, it goes to Step S22.

In Step S22, the luminance undershoot passband adjusting circuit 13 determines whether the value of the luminance signal Y now inputted is smaller than the requested lower limit. If it determines that the value is small, it goes to Step S23, and clips the value of the luminance signal Y now inputted to the same value as the lower limit.

If it is determined that no request is made for changing the lower limit of the passband in Step S21 (that is, if it is notified that the lower limit is not changed), if it is determined that the value of the luminance signal Y now inputted is equal to or greater than the lower limit of the passband in Step S22, or if the value of the luminance signal Y is clipped to the lower limit of the passband in Step S23, the luminance undershoot passband adjusting circuit 13 goes to Step S24, and supplies the value of the luminance signal Y to the compression circuit 15.

Subsequently, in Step S25, the luminance undershoot passband adjusting circuit 13 determines whether the luminance signal Y is inputted from the luminance overshoot passband adjusting circuit 12. If it determines that the luminance signal Y is inputted, it goes to Step S21, and similarly performs the process steps after that for the inputted luminance signal Y.

If it is determined that the luminance signal Y is not inputted from the luminance overshoot passband adjusting circuit 12 in Step S25, the luminance undershoot passband adjusting circuit 13 ends the process.

Next, the operation of the color difference passband adjusting circuit 14 will be described with reference to a flow chart shown in FIG. 6.

In Step S31, the color difference passband adjusting circuit 14 determines whether the input data passband control part 16 makes a request for changing the range of the passband for the color difference signals CB/CR in Step S3 in FIG. 3. If it determines that a request is made, it goes to Step S32.

In Step S32, the color difference passband adjusting circuit 14 determines whether the value of the color difference signals CB/CR now inputted is greater than the requested upper limit of the passband or smaller than the lower limit. If it determines that the value is greater or smaller, it goes to Step S33.

In Step S33, if the value of the color difference signals CB/CR now inputted is greater than the upper limit of the requested passband, the color difference passband adjusting circuit 14 clips the value to the same value as the upper limit, or if the value is smaller than the lower limit, it clips the value to the same value as the lower limit.

If it is determined that no request is made for changing the passband in Step S31 (that is, if it is notified that the passband is not changed), if it is determined that the value of the color difference signals CB/CR now inputted is the value in the range of the passband in Step S32, or if it is determined that the value of the color difference signals CB/CR is clipped in Step S33, the color difference passband adjusting circuit 14 goes to Step S34, and supplies the color difference signals CB/CR to the compression circuit 15.

Subsequently, in Step S35, the color difference passband adjusting circuit 14 determines whether the color difference signals CB/CR are inputted from the color signal generating circuit 11. If it determines that the color difference signals CB/CR are inputted, it returns to Step S31, and similarly performs the process steps after that for the inputted color difference signals CB/CR.

If it is determined that the color difference signals CB/CR are not inputted from the color signal generating circuit 11 in Step S35, the color difference passband adjusting circuit 14 ends the process.

As described above, it is requested to adjust the passband, and the luminance signal Y and the color difference signals CB/CR in the requested passband are compressed.

For example, in the cases in which it is desired to output the luminance signal Y in the integer range of 16 to 240 and in which it is desired to compress and output the color difference signals CB/CR in the integer range of 1 to 254, the input data passband control part 16 requests the luminance overshoot passband adjusting circuit 12 to change the upper limit of the passband for the luminance signal Y from 254 to 240, and requests the luminance undershoot passband adjusting circuit 13 to change the lower limit of the passband for the luminance signal Y from 1 to 16.

In addition, the input data passband control part 16 notifies the color difference passband adjusting circuit 14 that the passband is not changed.

As shown in FIG. 7A, in response to the request, in the luminance overshoot passband adjusting circuit 12, the luminance signal Y of 241 and above is clipped to 240, whereas in the luminance undershoot passband adjusting circuit 13, the luminance signal Y of 15 and below is clipped to 16, whereby the passband for the luminance signal Y is adjusted.

In addition, in the color difference passband adjusting circuit 14, in response to the request from the input data passband control part 16, as shown in FIG. 7B, the inputted color difference signals CB/CR in the range of 1 to 254 are outputted as they are (in this case, it is adjusted to all bandpass).

As described above, the luminance signal Y and the color difference signals CB/CR, both of them adjusted in their passbands, are compressed by the compression circuit 15.

As described above, for example, the passband for the luminance signal Y can be adjusted in the integer range of 0 to 255 representable by eight bits, which is a wider range than the integer range of 16 to 235 compliant to the BT.709 standards, whereas, for example, the passband for the color difference signals CB/CR can be adjusted in the integer range of 0 to 255 representable by eight bits, which is a wider range than the integer range of 16 to 240 compliant to the BT.709 standards. Therefore, video data corresponding to the display performance capabilities of the display device can be provided to the display device that can represent colors in a wider color gamut than predetermined standards such as BT.709.

In addition, the input data passband control part 16 controls the luminance signal Y or the passband for the color difference signals CB/CR in accordance with the display performance capabilities of the target display device, but it may control the passband in accordance with the luminance signal Y or the color difference signals CB/CR to be inputted.

Next, a series of the process steps described above may be performed by hardware or may be by software. In the case in which a series of the process steps is performed by software, a program configuring the software is installed in a multipurpose computer.

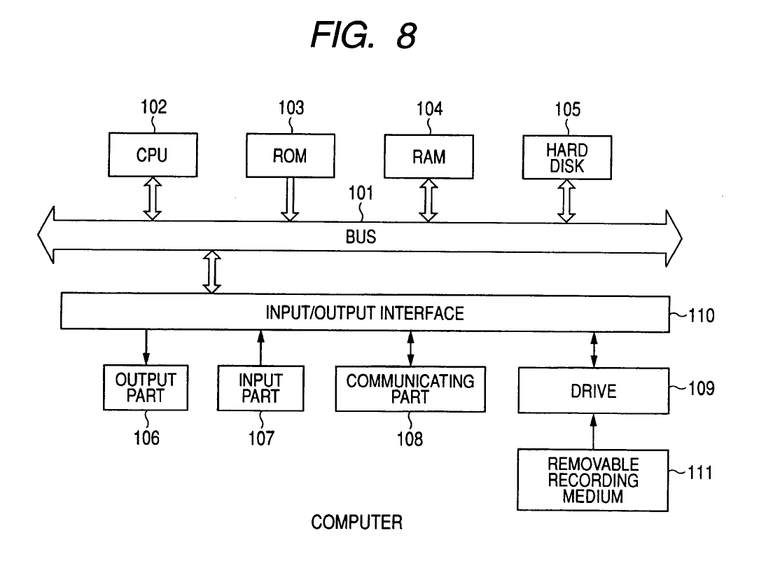

Then, FIG. 8 shows an exemplary configuration of a computer in which a program performing a series of the process steps described above is installed.

The program can be recorded in advance on a hard disk 105 or a ROM 103 as a recording medium incorporated in the computer.

Alternatively, the program can be temporarily or permanently stored (recorded) on a removable recording medium 111 such as a flexible disc, a CD-ROM (Compact Disc Read Only Memory), an MO (Magneto-optical) disc, a DVD (Digital Versatile Disc), a magnetic disc, and a semiconductor memory. The removable recording medium 111 like this can be provided as so-called package software.

Moreover, the program is installed into the computer through the removable recording medium 111 as described above, as well as it can be installed into the hard disk 105 incorporated in the computer from a download site through an artificial satellite for digital satellite broadcast over radio transmission, or installed into the computer through a network such as a LAN (Local Area Network) and the Internet over cable transmission, or installed into the incorporated hard disk 105 by receiving the program thus transmitted by a communicating part 108 in the computer.

The computer has a CPU (Central Processing Unit) 102 therein. To the CPU 102, an I/O interface 110 is connected through a bus 101. When a user manipulates an input part 107 configured of a keyboard, a mouse, a microphone, etc., to enter an instruction to the CPU 102 through the I/O interface 110, it runs the program stored in the ROM (Read Only Memory) 103. Alternatively, the CPU 102 loads into a RAM (Random Access Memory) 104 the program that is stored in the hard disk 105, the program that is transmitted through a satellite or a network, received at the communicating part 108, and installed in the hard disk 105, or the program that is read out of the removable recording medium 111 mounted on a drive 109 and installed into the hard disk 105 for implementation. Thus, the CPU 102 performs the process steps in accordance with the flow charts described above, or runs the process steps performed by the configurations in the block diagrams shown.

Then, the CPU 102 outputs the process results from an output part 106 configured of an LCD (Liquid Crystal Display) and a speaker through the I/O interface 110, etc., as necessary, or transmits the process results from the communicating part 108, or further records the process results on the hard disk 105.

Here, in the specification, the process steps describing the program to allow the computer to run various processes are not necessarily performed in time series along the order described in flow charts, which include the process steps performed in parallel or separately (for example, parallel processing or processing by an object).

In addition, the program may be processed in a single computer, or may be processed by a plurality of computers in distributed processing. Furthermore, the program may be forwarded to a remote computer for implementation.

Moreover, an embodiment of the invention is not limited to the embodiments described above, which can be modified within the scope not deviating from the teaching of an embodiment of the invention.

It should be understood by those skilled in the art that various modifications, combinations, sub-combinations and alterations may occur depending on design requirements and other factors insofar as they are within the scope of the appended claims or the equivalents thereof.

What is claimed is:

1. A signal processing apparatus in which a luminance signal in a first numeric range is assigned to an integer value in a second integer range that is narrower than a first integer range representable by a plurality of predetermined bits for representation, and a luminance signal and color difference signals are outputted in compliance with a predetermined standard in which a color difference signal in a second numeric range is assigned to an integer value in a third integer range that is narrower than the first integer range for representation, the signal processing apparatus comprising:
a luminance signal assigning means for assigning the luminance signal in the first numeric range to an integer value in a fourth integer range that is narrower than the first integer range and wider than the second integer range;
a color difference signal assigning means for assigning the color difference signals in the second numeric range to an integer value in a fifth integer range that is narrower than the first integer range and wider than the third integer range; and
an adjusting means for adjusting the fourth integer range in a range that is narrower than the first integer range and wider than the second integer range, and adjusting the fifth integer range in a range that is narrower than the first integer range and wider than the third integer range.

2. A signal processing method in which a luminance signal in a first numeric range is assigned to an integer value in a second integer range that is narrower than a first integer range representable by a plurality of predetermined bits for representation, and a luminance signal and color difference signals are outputted in compliance with a predetermined standard in which a color difference signal in a second numeric range is assigned to an integer value in a third integer range that is narrower than the first integer range for representation, the signal processing method comprising the steps of:
assigning the luminance signal in the first numeric range to an integer value in a fourth integer range that is narrower than the first integer range and wider than the second integer range;
assigning the color difference signals in the second numeric range to an integer value in a fifth integer range that is narrower than the first integer range and wider than the third integer range; and
adjusting the fourth integer range in a range that is narrower than the first integer range and wider than the second integer range, and adjusting the fifth integer range in a range that is narrower than the first integer range and wider than the third integer range.

3. A program which allows a computer to execute an output process in which a luminance signal in a first numeric range is assigned to an integer value in a second integer range that is narrower than a first integer range representable by a plurality of predetermined bits for representation, and a luminance signal and color difference signals are outputted in compliance with a predetermined standard in which a color difference signal in a second numeric range is assigned to an integer value in a third integer range that is narrower than the first integer range for representation, the output process comprising the steps of:
assigning the luminance signal in the first numeric range to an integer value in a fourth integer range that is narrower than the first integer range and wider than the second integer range;
assigning the color difference signals in the second numeric range to an integer value in a fifth integer range that is narrower than the first integer range and wider than the third integer range; and
adjusting the fourth integer range in a range that is narrower than the first integer range and wider than the second integer range, and adjusting the fifth integer range in a range that is narrower than the first integer range and wider than the third integer range.

4. A signal processing apparatus in which a luminance signal in a first numeric range is assigned to an integer value in a second integer range that is narrower than a first integer range representable by a plurality of predetermined bits for representation, and a luminance signal and color difference signals are outputted in compliance with a predetermined standard in which a color difference signal in a second numeric range is assigned to an integer value in a third integer range that is narrower than the first integer range for representation, the signal processing apparatus comprising:
a luminance signal assigning unit configured to assign the luminance signal in the first numeric range to an integer value in a fourth integer range that is narrower than the first integer range and wider than the second integer range;
a color difference signal assigning unit configured to assign the color difference signals in the second numeric range to an integer value in a fifth integer range that is narrower than the first integer range and wider than the third integer range; and
an adjusting unit configured to adjust the fourth integer range in a range that is narrower than the first integer range and wider than the second integer range, and adjusting the fifth integer range in a range that is narrower than the first integer range and wider than the third integer range.
